(19) United States
(12) Patent Application Publication
(10) Pub. No.: US 2010/0087598 A1
(43) Pub. Date: Apr. 8, 2010

(54) POLYMER AND COATING COMPOSITION COMPRISING THE SAME

(76) Inventors: Shanti Swarup, Allison Park, PA (US); Mark E. Endlish, Chicora, PA (US); Craig Niederst, Allison Park, PA (US)

Correspondence Address: PPG INDUSTRIES INC;INTELLECTUAL PROPERTY DEPT, ONE PPG PLACE, PITTSBURGH, PA, 15272, US

(21) Appl. No.: 12/244,866

(22) Filed: Oct. 3, 2008

(51) Int. Cl. C08F 8/30; C08F 222/10; C08F 218/02; C08L 67/04; C08F 220/26; C08F 8/00

(52) U.S. Cl. 525/123; 526/72; 526/321; 526/319; 526/320; 525/55; 525/165

(57) ABSTRACT

The present invention is directed to a polymer comprising the reaction product of (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; (iii) at least one monomer that is reactive with (i) and/or (ii); wherein the reaction product is not further reacted with any other monomer comprising an ethylenically unsaturated double bond; and wherein said reaction product comprises a reactive functional group.

### BACKGROUND OF THE INVENTION

1. Field of the Invention

The present invention relates to a polymer and a coating composition containing said polymer.

2. Background Information

A variety of industries, such as the automotive OEM and industrial industries, incorporate polymers in various coatings that are used in those industries. For example, in the automotive OEM industry, the coating system (i.e., finish) that is applied onto an automobile or truck body typically comprises an electrodepositable coating layer, a primer surfacer layer deposited onto at least a portion of the electrodepositable coating layer, at least one color imparting basecoat layer deposited onto at least a portion of the primer surfacer layer, and a clear coat layer deposited onto at least a portion of the basecoat layer. These layers are deposited from coating compositions which utilize polymers as a film forming component.

### SUMMARY OF THE INVENTION

The present invention is directed to a polymer comprising the reaction product of (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii); wherein the reaction product is not further reacted with any other monomer comprising an ethylenically unsaturated double bond; and wherein said reaction product comprises a reactive functional group.

The present invention is further directed to a polymer consisting essentially of the reaction product of (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii); wherein the reaction product is not further reacted with any other monomer comprising an ethylenically unsaturated double bond; and wherein said reaction product comprises a reactive functional group.

The present invention is further directed to a coating composition comprising (1) a polymer that comprises the reaction product of (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii); wherein the reaction product is not further reacted with any other monomer comprising an ethylenically unsaturated double bond; and wherein said reaction product comprises a functional group; and (2) a crosslinking agent that is reactive with the functional group of the reaction product.

The present invention is further directed to a method of forming a functional group containing polymer comprising: (a) providing (i) a monomer comprising at least two ethylenically unsaturated double bonds; (ii) a monomer comprising a carbon atom that is connected to four moieties wherein one of the moieties comprises a hydrogen atom and the remainder of the moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii); (b) providing a polymerization initiator; (c) heating (a) and (b) thereby forming the polymer; and wherein the polymer is not further reacted with any other monomer comprising an ethylenically unsaturated double bond.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Plural encompasses singular and vice versa. For example, although reference is made herein to “an” organic solvent, “a” monomer comprising at least two ethylenically unsaturated double bonds, “a” monomer comprising a carbon atom that is connected to four moieties wherein one of the moieties comprises a hydrogen atom and the remainder of the moieties comprises an alkyl group, a combination (a plurality) of these components can be used in the present invention.

As used herein, “plurality” means two or more.

As used herein, “includes” and like terms means “including without limitation.”

When referring to any numerical range of values, such ranges are understood to include each and every number and/or fraction between the stated range minimum and maximum.

As used herein, “molecular weight” means weight average molecular weight (M_{w}) as determined by Gel Permeation Chromatography.

As used herein, the term “cure” refers to a coating wherein any crosslinkable components of the composition are at least partially crosslinked. In certain embodiments, the crosslink density of the crosslinkable components (i.e., the degree of crosslinking) ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

Reference to any monomer(s) herein refers generally to a monomer that can be polymerized with another polymerizable compound such as another monomer or polymer. Unless otherwise indicated, it should be appreciated that once the monomer components react with one another to form the compound, the compound will comprise the residues of the monomer components.

### Polymer

As stated above, the present invention is directed to a polymer and a coating composition comprising the polymer. In certain embodiments, the polymer described herein is the polymeric reaction product of: (i) a monomer comprising at least two ethylenically unsaturated double bonds; (ii) a monomer comprising a carbon atom that is connected to four moieties wherein one of the moieties comprises a hydrogen atom and the remainder of the moieties comprise an alkyl group, wherein one of the alkyl group containing moieties comprises an ethylenically unsaturated double bond, and wherein none of the alkyl group containing moieties form a cycloaliphatic ring; (iii) at least one monomer that is reactive with (i) and/or (ii). The reaction product that is formed from reactive components (i), (ii), and (iii) comprises a reactive functional group and the reaction product is not further reacted with any other monomer comprising an ethylenically unsaturated double bond. As used herein, the phrase “reactive functional group” means hydroxyl, carboxyl, carbamate, epoxy, isocyanate, aceto acetate, amine, mercaptan, or combinations thereof. Additionally, the reaction product that is formed from reactive components (i), (ii), and (iii) is a branched reaction product. In some embodiments, the polymer “consists of” or “consists essentially of” the reaction product of reactive components (i), (ii), and (iii).

In certain embodiments, the molecular weight of the reaction product can be ≧500. In other embodiments, the molecular weight of the reaction product can be ≦2000. In certain embodiments, the molecular weight of the reaction product can range between any combination of values, which were recited in the preceding sentences, inclusive of the recited values. For example, in certain embodiments, the molecular weight of the reaction product can range from 1000 to 1500.

Reactive component (i) may comprise any monomer known in the art which comprises at least two ethylenically unsaturated double bonds. Suitable monomers that may be used as reactive component (i) include, without limitation, di(meth)acrylates (e.g., hexanediol(meth)diacrylate), ethylene glycol di(meth)acrylate, butanediol di(meth)acrylate, decandediol di(meth)acrylate, or a combination of di(meth)acrylates.

In certain embodiments, reactive component (i) comprises ≧5% by weight of the polymeric reaction product. In other embodiments, reactive component (i) comprises ≦50% by weight of the polymeric reaction product. In certain embodiments, the total amount of reactive component (i) in the polymeric reaction product can range between any combination of values, which were recited in the preceding sentences, inclusive of the recited values. For example, in certain embodiments, the total amount of reactive component (i) can range from 7% to 15% by weight of the total polymeric reaction product.

Reactive component (ii) may comprise any monomer known in the art which comprises a carbon atom that is connected to four moieties wherein one of the moieties comprises a hydrogen atom and the remainder of the moieties comprises an alkyl group. One of the alkyl group containing moieties comprises an ethylenically unsaturated double bond and none of the alkyl group containing moieties form a cycloaliphatic ring. Suitable monomers that may be used as reactive component (ii) include, without limitation, 2-ethyl hexyl(meth)acrylate, 2-butyl hexyl(meth)acrylate, 2-methyl hexyl(meth)acrylate, or combinations thereof. It should be noted that in some embodiments, the monomer used as component (ii) may or may not comprise a reactive functional group.

In certain embodiments, reactive component (ii) comprises ≧2% by weight of the total polymeric reaction product. In other embodiments, reactive component (ii) comprises ≦15% by weight of the total polymeric reaction product. In certain embodiments, the total amount of reactive component (ii) in the polymeric reaction product can range between any combination of values, which were recited in the preceding sentences, inclusive of the recited values. For example, in certain embodiments, the total amount of reactive component (ii) can range from 2% to 5% by weight of the total polymeric reaction product.

Reactive component (iii) may comprise any monomer that is reactive with reactive components (i) and/or (ii). In certain embodiments, reactive component (iii) may also comprise a combination of monomers wherein one monomer is reactive with reactive component (i) and the other monomer is reactive with reactive component (ii). In some embodiments, reactive component (iii) may comprise a combination of monomers wherein a first monomer is reactive with reactive components (i) and/or (ii) and a second monomer is reactive with the first monomer. Suitable monomers that may be used as reactive component (iii) include, without limitation, styrene, hydroxy functional (meth)acrylates (e.g., hydroxyethyl(meth)acrylate, hydroxy butyl(meth)acrylate, hydroxy propyl(meth)acrylate), or combinations thereof. Like reactive component (ii), reactive component (iii) may or may not comprise a reactive functional group. However, at least one of the reactive components (ii) and (iii) must comprise a reactive functional group. If both of the monomers used as reactive components (ii) and (iii) comprise reactive functional groups, then it should be noted that the reactive functional groups can either be the same or different.

In certain embodiments, reactive component (iii) comprises ≧35% by weight of the total polymeric reaction product. In other embodiments, reactive component (iii) comprises ≦90% by weight of the total polymeric reaction product. In certain embodiments, the total amount of reactive component (iii) in the polymeric reaction product can range between any combination of values, which were recited in the preceding sentences, inclusive of the recited values. For example, in certain embodiments, the total amount of reactive component (iii) can range from 60% to 80% by weight of the total polymeric reaction product.

In certain embodiments, the reaction product described above is formed by mixing the above identified reactive components in a reaction vessel with an organic solvent and a polymerization initiator. Any organic solvents known in the art may be used in the formation of the polymer. Suitable organic solvents that may be used in the formation of the polymer include, without limitation, methylisobutyl ketone, mixtures of hydrocarbons such as AROMATIC 100 (commercially available from Ashland Chemicals, Inc.), xylene, toluene, or combinations thereof. Any polymerization initiators known in the art may also be used in the formation of the polymer described above. Suitable polymerization initiators include, without limitation, ditertiary butyl peroxide, tertiary butyl peroxy acetate, ditertiary amyl peroxide, or combinations thereof. After the reaction vessel is charged with the reactive components described above, the reaction vessel can then be heated for a time period ranging from 2 hours to 6 hours, such as 4 hours, at a temperature ranging from 60° C. to 200° C., such as 120° C. to 180° C., in order to form the polymer.

### Coating Composition Comprising the Polymer

The present invention is also directed to a coating composition comprising the polymer described above. In addition to the polymer described herein, the coating composition can also comprise a crosslinking agent (crosslinker) that is reactive with the reactive functional group(s) of the polymeric reaction product. Suitable crosslinking agents include, without limitation, aminoplasts, polyisocyanates (including blocked isocyanates), polyepoxides, beta-hydroxyalkylamides, polyacids, anhydrides, organometallic acid-functional materials, polyamines, polyamides, cyclic carbonates, siloxanes, or combinations thereof.

In certain embodiments, the crosslinking agent comprises ≧10% by weight of the total resin solids of the coating composition. In other embodiments, the crosslinking agent comprises ≦40% by weight of the total resin solids of the coating composition. In certain embodiments, the total amount of crosslinking agent in the coating composition can range between any combination of values, which were recited in the preceding sentences, inclusive of the recited values. For example, in certain embodiments, the total amount of crosslinking agent can range from 25% by weight to 35% by weight, such as 28% by weight, of the total resin solids of the coating composition.

The coating composition described herein may further comprise additional ingredients such as colorants. As used herein, the term “colorant” means any substance that imparts color and/or other opacity and/or other visual effect to the composition. The colorant can be added to the coating in any suitable form, such as discrete particles, dispersions, solutions and/or flakes (e.g., aluminum flakes). A single colorant or a mixture of two or more colorants can be used in the coating composition described herein.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, or mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating composition described herein. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The coating compositions can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, pigments, fillers, organic cosolvents, catalysts, including phosphonic acids and other customary auxiliaries.

In addition to the materials described above, the coating composition can also comprise an organic solvent. Suitable organic solvents that can be used in the coating composition include any of those listed in the preceding paragraphs as well as butyl acetate, xylene, methyl ethyl ketone, or combinations thereof.

In certain embodiments, the coating composition of the present invention, after application to a substrate and after curing, demonstrates a 20° gloss retention of at least 80%, such as greater than 90%, when subjected to SCRATCH TESTING METHOD 1. The test begins by measuring the 20° gloss of the cured coating (“original gloss”) , which has been applied onto a substrate, prior to subjecting the coated substrate to the Amtec-Kistler Car Wash Test DIN 55668. For each of the SCRATCH TESTING METHODS described herein, the gloss measurement is taken by using a gloss meter such as the NOVO GLOSS-GARDCO gloss meter available from Paul N. Gardner Co. (Pompano Beach, Fla.). After the gloss measurement is obtained, the coated substrate is then subjected to 10 cycles of the Amtec-Kistler Car Wash Test. After the 10 cycles are complete, the 20° gloss of the coating is again measured (“gloss after mar”). The 20° gloss retention of the coating is determined using formula I below:

(gloss after mar/original gloss)×100=gloss retention (I)

In certain embodiments, the coating composition of the present invention, after application to a substrate and after curing, demonstrates a 20° gloss retention of at least 70%, such as greater than 80%, or greater than 90%, when subjected to SCRATCH TESTING METHOD 2. SCRATCH TESTING METHOD 2 is conducted in the same manner as SCRATCH TESTING METHOD 1 but for the fact that the coated substrate is subjected to 20 cycles of the Amtec-Kistler Car Wash Test as opposed to 10 cycles.

In certain embodiments, the coating composition of the present invention, after application to a substrate and after curing, demonstrates a 20° gloss retention of at least 60%, such as greater than 70%, greater than 80%, or greater than 90%, when subjected to SCRATCH TESTING METHOD 3. SCRATCH TESTING METHOD 3 is conducted in the same manner as SCRATCH TESTING METHOD 1, but for the fact that the coated substrate is subjected to 30 cycles of the Amtec-Kistler Car Wash Test as opposed to 10 cycles.

In certain embodiments, the coating composition of the present invention, after application to a substrate and after curing, demonstrates a 20° gloss retention of at least 50%, such as greater than 60%, greater than 70%, greater than 80%, when subjected to SCRATCH TESTING METHOD 4. SCRATCH TESTING METHOD 4 is conducted in the same manner as SCRATCH TESTING METHOD 1, but for the fact that the coated substrate is subjected to 40 cycles of the Amtec-Kistler Car Wash Test as opposed to 10 cycles.

In certain embodiments, the coating composition of the present invention, after application to a substrate and after curing, demonstrates a 20° gloss recovery of at least 5%, such as from 5% to 10%, when subjected to SCRATCH RECOVERY TESTING METHOD 1. The test begins by measuring the 20° original gloss of the cured coating prior to subjecting the coated substrate into the Amtec-Kistler Car Wash Test DIN 55668. After the gloss measurement is obtained, the coated substrate is then subjected to 10 cycles of the Amtec-Kistler Car Wash Test. After the 10 cycles, the 200 gloss after mar is measured prior to heating the substrate. The coated substrate is then heated to a substrate temperature of 54.44° C. for a duration of 5 minutes in a thermal convection oven. After this heating period, the substrate is removed from the oven and allowed to cool at ambient room temperature. After the substrate has cooled, the 20° gloss after heating of the coating is measured again (“gloss after heating”). The 20° gloss recovery of the coating is determined using formulas I, II, and III below:

(gloss after mar/original gloss)×100=gloss retention (I)

(gloss after heating/original gloss)×100=recovery (II)

recovery−gloss retention=gloss recovery (III)

In certain embodiments, the coating composition of the present invention, after application to a substrate and after curing, demonstrates a 20° gloss recovery of at least 4%, such as from 4% to 10%, when subjected to SCRATCH RECOVERY TESTING METHOD 2. SCRATCH RECOVERY TESTING METHOD 2 is conducted in the same manner as SCRATCH RECOVERY TESTING METHOD 1, but for the fact that the coated substrate is subjected to 20 cycles of the Amtec-Kistler Car Wash Test as opposed to 10 cycles.

In certain embodiments, the coating composition of the present invention, after application to a substrate and after curing, demonstrates a 20° gloss recovery of at least 3%, such as from 3% to 10%, when subjected to SCRATCH RECOVERY TESTING METHOD 3. SCRATCH RECOVERY TESTING METHOD 3 is conducted in the same manner as SCRATCH RECOVERY TESTING METHOD 1, but for the fact that the coated substrate is subjected to 30 cycles of the Amtec-Kistler Car Wash Test as opposed to 10 cycles.

In certain embodiments, the coating composition of the present invention, after application to a substrate and after curing, demonstrates a 20° gloss recovery of at least 2%, such as from 2% to 10%, when subjected to SCRATCH RECOVERY TESTING METHOD 4. SCRATCH RECOVERY TESTING METHOD 4 is conducted in the same manner as SCRATCH RECOVERY TESTING METHOD 1, but for the fact that the coated substrate is subjected to 40 cycles of the Amtec-Kistler Car Wash Test as opposed to 10 cycles.

### Substrate with a Coating System

The coating composition described herein may be applied as part of a coating system that can be deposited onto a number of different substrates. The coating system typically comprises a number of coating layers. A coating layer is typically formed when a coating composition that is deposited onto the substrate is substantially cured by methods known in the art (e.g., by thermal heating). It is noted that the coating composition described above can be used in one or more of the coating layers described in the following paragraphs.

Suitable substrates that can be coated with the coating composition comprising the polymer include, without limitation, metal substrates, metal alloy substrates, and/or substrates that has been metallized, such as nickel plated plastic. In some embodiments, the metal or metal alloy can be aluminum and/or steel. For example, the steel substrate could be cold rolled steel, electrogalvanized steel, and hot dipped galvanized steel. Moreover, in some embodiments, the substrate may comprise a portion of a vehicle such as a vehicular body (e.g., without limitation, door, body panel, trunk deck lid, roof panel, hood, and/or roof) and/or a vehicular frame. As used herein, “vehicle” or variations thereof includes, but is not limited to, civilian, commercial, and military land vehicles such as cars, motorcycles, and trucks. It will also be understood that, in some embodiments, the substrate may be pretreated with a pretreatment solution, such as a zinc phosphate solution as described in U.S. Pat. Nos. 4,793,867 and 5,588,989, which are incorporated herein by reference, or not pretreated with a pretreatment solution.

For clarity, when referring to a “substrate” herein, it should be noted that the substrate may or may not be pretreated and/or may or may not have an electrodepositable coating.

In a conventional coating system, a pretreated substrate is coated with an electrodepositable coating composition. After the electrodepositable coating composition is cured, a primer-surfacer coating composition is applied onto a least a portion of the electrodepositable coating composition. The primer-surfacer coating composition is typically applied to the electrodepositable coating layer and cured prior to a subsequent coating composition being applied over the primer-surfacer coating composition. However, it should be noted that in some embodiments, the substrate is not coated with an electrodepositable coating composition. Accordingly, in these embodiments, the primer-surfacer coating composition is applied directly onto the substrate.

The primer-surfacer layer that results from the primer-surfacer coating composition serves to enhance chip resistance of subsequently applied coating layers (e.g., color imparting coating composition and/or substantially clear coating composition) as well as aid in the appearance of the subsequently applied layers. As used herein and in the claims, “primer-surfacer” refers to a primer composition for use under a subsequently applied coating composition, and includes such materials as thermoplastic and/or crosslinking (e.g., thermosetting) film-forming resins generally known in the art of organic coating compositions. Suitable primers and primer-surfacer coating compositions include spray applied primers, as are known to those skilled in the art. Examples of suitable primers include several available from PPG Industries, Inc., Pittsburgh, Pa., as DPX-1791, DPX-1804, DSPX-1537, GPXH-5379, OPP-2645, PCV-70118, and 1177-225A. Another suitable primer-surfacer coating composition that can be utilized in the present invention is the primer-surfacer described in U.S. patent application Ser. No. 11/773,482, which is incorporated in its entirety herein by reference.

It should be noted that in some embodiments, the primer-surfacer coating composition is not used in the coating system. Therefore, a color imparting basecoat coating composition can be applied directly onto the cured electrodepositable coating composition.

In some embodiments, a color imparting coating composition (hereinafter, “basecoat”) is deposited onto at least a portion of the primer surfacer coating layer (if present). Any basecoat coating composition known in the art may be used in the present invention. It should be noted that these basecoat coating compositions typically comprise a colorant.

In certain embodiments, a substantially clear coating composition (hereinafter, “clearcoat”) is deposited onto at least a portion of the basecoat coating layer. As used herein, a “substantially clear” coating layer is substantially transparent and not opaque. In certain embodiments, the substantially clear coating composition can comprise a colorant but not in an amount such as to render the clear coating composition opaque (not substantially transparent) after it has been cured. Any clearcoat coating composition known in the art may be used in the present invention. For example, the clearcoat coating composition that is described in U.S. Pat. Nos. 5,989,642, 6,245,855, 6,387,519, and 7,005,472, which are incorporated in their entirety herein by reference, can be used in the coating system. In certain embodiments, the substantially clear coating composition can also comprise a particle, such as a silica particle, that is dispersed in the clearcoat coating composition (such as at the surface of the clearcoat coating composition after curing). In some embodiments, the coating composition comprising the polymer described herein can be used as the clearcoat coating composition.

One or more of the coating compositions described in the preceding paragraphs can comprise the colorants and the other optional materials (which are known in the art of formulated surface coatings) described above.

It will be further appreciated that one or more of the coating compositions that form the various coating layers described herein can be either “one component” (“1K”), “two component” (“2K”), or even multi-component compositions. A 1K composition will be understood as referring to a composition wherein all of the coating components are maintained in the same container after manufacture, during storage, etc. A 1K coating can be applied to a substrate and cured by any conventional means, such as by heating, forced air, and the like. The present coatings can also be 2K coatings or multi-component coatings, which will be understood as coating in which various components are maintained separately until just prior to application.

The coating compositions that form the various coating layers described herein can be deposited or applied onto the substrate using any technique that is known in the art. For example, the coating compositions can be applied to the substrate by any of a variety of methods including, without limitation, spraying, brushing, dipping, and/or roll coating, among other methods. When a plurality of coating compositions are applied onto a substrate, it should be noted that one coating composition may be applied onto at least a portion of an underlying coating composition either after the underlying coating composition has been cured or prior to the underlying coating composition being cured. If the coating composition is applied onto an underlying coating composition that has not been cured, both coating compositions may be cured simultaneously.

The coating compositions may be cured using any technique known in the art such as, without limitation, thermal energy, infrared, ionizing or actinic radiation, or by any combination thereof. In certain embodiments, the curing operation can be carried out at temperatures ≧10° C. In other embodiments, the curing operation can be carried out at temperature ≦246° C. In certain embodiments, the curing operation can carried out at temperatures ranging between any combination of values, which were recited in the preceding sentences, inclusive of the recited values. For example, the curing operation can be carried out at temperatures ranging from 120° C.-150° C. It should be noted, however, that lower or higher temperatures may be used as necessary to activate the curing mechanisms.

In certain embodiments, the coating compositions described herein is a low temperature, moisture curable coating compositions. As used herein, the term “low temperature, moisture curable” refers to coating compositions that, following application to a substrate, are capable of curing in the presence of ambient air, the air having a relative humidity of 10% to 100%, such as 25% to 80%, and a temperature in the range of −10° C. to 120° C., such as 5° C. to 80° C., in some cases 10° C. to 60° C. and, in yet other cases, 15° C. to 40° C.

The dry film thickness of the coating layers described herein can range from 0.1 micron to 500 microns. In other embodiments, the dry film thickness can be ≦125 microns, such as ≦80 microns. For example, the dry film thickness can range from 15 microns to 60 microns.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

Clearcoat Example 1: Polymer with Hydroxy Butyl Acrylate (HBA)

| | Solid Weight | Weight |
|---|---|---|
| Ingredient | (grams) | (grams) |
| PACK 1 | | |
| SOLVESSO 100 | — | 60.00 |
| TINUVIN 292¹ | — | 1.00 |
| TINUVIN 928² | — | 1.50 |
| 07-SAB-354³ | 58.00 | 80.78 |
| Melamine resin⁴ | 8.00 | 10.00 |
| Polyester Polyol⁵ | 10.00 | 11.11 |
| BYK 306⁶ | 0.03 | 0.25 |
| PACK 2 | | |
| Phenyl Acid Phosphate⁷ | 0.50 | 0.67 |
| DESMODUR N-3300A⁸ | 24.00 | 24.00 |
| TOTAL | 100.53 | 189.31 |

¹Light stabilizer available from Ciba Additives.
²UV absorber available from Ciba Specialty Chemicals
³A polymer consisting of 27.01% hydroxybutyl acrylate, 14.79% Styrene, 24.46% methyl acrylate, 7.79% butyl methacrylate, 2.02% 1, 6 hexane diol diacrylate (HDDA), 9.6% 2-ethylhexyl acrylate, 10.0% methyl methacrylate, 4.33% DTAP at 71% solids and 532 OH Eq. Wt.
⁴Cymel 202 melamine resin available from Cytec.
⁵HPH-7700 (reaction product of neopentyl glycol (NPG) and Hexahydrophthalic anhydride (HHPA))
⁶Polyether/dimethylpolysiloxane copolymer available from Byk Chemie.
⁷Phenyl Acid Phosphate⁷
⁸Hexamethylene polyisocyanate available from Bayer Material Science LLC

Clearcoat Example 2: Polymer with Hydroxyethyl
Methacrylate (HEMA)

| | Solid Weight | Weight |
|---|---|---|
| Ingredient | (grams) | (grams) |
| PACK 1 | | |
| SOLVESSO 100 | — | 60.00 |
| TINUVIN 292 | — | 1.00 |
| TINUVIN 928 | — | 1.50 |
| 07-SAB-362⁹ | 58.00 | 80.78 |
| Melamine resin | 8.00 | 10.00 |
| Polyester Polyol | 10.00 | 11.11 |
| BYK 306 | 0.03 | 0.25 |
| PACK 2 | | |
| Phenyl Acid Phosphate | 0.50 | 0.67 |
| DESMODUR N-3300A | 24.00 | 24.00 |
| TOTAL | 100.53 | 189.31 |

⁹A polymer consisting of 27.01% hydroxyethyl methacrylate, 14.79% Styrene, 24.46% methyl acrylate, 17.79% butyl methacrylate, 9.6% 2-ethylhexyl acrylate, 2.02% HDDA, 4.33% DTAP at 71% solids and 532 OH Eq. Wt.

The film forming compositions (Examples 1-2) were spray applied to a pigmented basecoat to form color-plus-clear composite coatings over primed electrocoated steel panels. The panels use were ACT cold roll steel panels (10.16 cm by 30.48 cm) with ED6060 electrocoat available from ACT Laboratories, Inc. The panels were coated with UNISCHWARZ, a black pigmented water-borne basecoats available from PPG Industries, Inc, and others. The basecoat was automated spray applied to the electrocoated steel panels at ambient temperature (about 70° F. (21° C.)). A dry film thickness of about 0.5 to 0.6 mils (about 12 to 15 micrometers) was targeted for the basecoat. The basecoat panels were dehydrated for 5 minutes @ 176° F. (80° C.) prior to clearcoat application.

The clear coating compositions were each automated spray applied to a basecoated panel at ambient temperature in two coats with an ambient flash between applications. Clearcoats were targeted for a 1.7 mils (about 43 micrometers) dry film thickness. All coatings were allowed to air flash at ambient temperature before the oven. Panels were baked for thirty minutes at 285° F. (140° C.) to fully cure the coating(s).

TABLE 1

| | | Car Wash - Cycles | | | |
|---|---|---|---|---|---|
| | | (Gloss after mar) | | | |
| | 20° | [gloss after heating] | | | |
| | Original | 10 | 20 | 30 | 40 |
| Clearcoat | Gloss | cycles | cycles | cycles | cycles |
| Conventional | 85 | (51) | (35) | (25) | (11) |
| Clearcoat | | | | | |
| (comparative) | | | | | |
| Example 1 | 84 | (76) | (71) | (67) | (65) |
| | | [80] | [75] | [70] | [66] |
| Example 2 | 88 | (73) | (65) | (55) | (47) |
| | | [78] | [70] | [65] | [54] |

Table 1 shows the 20° gloss measurements for a conventional clear coat as well as for clear coat Examples 1 and 2 of the present invention. The gloss measurements were measured using a NOVO GLOSS-GARDCO gloss meter (available from Paul N. Gardner Co., Pompano Beach, Fla.).

Each coating's 20° gloss measurement (original gloss) was taken after the coating had been cured onto a panel (substrate), but prior to subjecting the coated panel to the Amtec-Kistler Car Wash Test DIN 55668. After the original gloss measurement was taken, each of the coated panels was subjected to the Amtec-Kistler Car Wash Test at 10, 20, 30, and 40 cycles. After being subjected to the Amtec-Kistler Car Wash Test, the 20° gloss measurement (gloss after mar) was again taken. After the test was complete, the panels were placed in an oven, which was held at 55.44° C., for 5 minutes. The panels were then removed from the oven and allowed to cool at ambient room temperature. The 20° gloss measurement (gloss after heating) for each panel was then taken again.

As can be seen from Table 1, the clear coats (Examples 1 and 2) of the present invention demonstrated a 20° gloss recovery of at least 80%, at least 70%, at least 60%, and at least 50% after being subjected to 10 cycles, 20 cycles, 30 cycles, and 40 cycles, respectively, of the Amtec-Kistler Car Wash Test DIN 55668. Surprisingly, these results were far surperior to the 20° gloss recovery of the conventional clear coat which demonstrated a gloss recovery of 59%, 41%, 29%, and 13% after being subjected to 10 cycles, 20 cycles, 30 cycles, and 40 cycles, respectively, of the Amtec-Kistler Car Wash Test DIN 55668.

TABLE 2

| | Chemical Tests |
|---|---|
| | Gradient Oven |
| Clearcoat | 1% NaOH |
| Conventional or | 52° C. |
| comparative | |
| (TKU1050) | |
| Example 1 | 74° C. |
| Example 2 | 57° C. |

Table 2 shows the chemical resistance of a conventional clear coat as well as for clear coat Examples 1 and 2 of the present invention to 1% sodimum hydroxide. The test was conducted in a BYK GARDNER-CAT. NO. 2602 gradient oven (available from BYK-Gardner USA, Columbia, Md.). The gradient oven is set so that a temperature gradient extends along the length of a 12 inch long×4 inch wide panel. One end of the panel is held at 35° C. (first end) while the other end of the panel is held at 81° C. (second end). Accordingly, the temperature of the panel increases from the first end towards the second end. Approximately 27 drops of sodium hydroxide, each having a size of 25 μl, were placed along the length of the panel. The panel was then heated in an oven for thirty minutes and then removed. The panel was then rinsed with de-ionized water and dried. After the panel was dried, the panel was inspected to determine at what temperature the liquid marked (etched) the coating.

As can be seen from Table 2, Example 1 of the present invention was not etched by the NaOH until 74° C. while Example 2 of the present invention was not etched by the NaOH until 66° C. On the other hand, the conventional clear coat was etched by the NaOH at a lower temperature than both Examples 1 and 2, namely at 61° C.

What is claimed is:

1. A polymer comprising the reaction product of (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii); wherein the reaction product is not further reacted with any other monomer comprising an ethylenically unsaturated double bond; and wherein said reaction product comprises a functional group.

2. The polymer according to claim 1, wherein (i) comprises a diacrylate.

3. The polymer according to claim 1, wherein (ii) comprises 2-ethyl hexyl(meth)acrylate, 2-butyl hexyl(meth)acrylate, 2-methyl hexyl(meth)acrylate, or combinations thereof.

4. The polymer according to claim 1, wherein (iii) comprises a hydroxy functional (meth)acryalte.

5. The polymer according to claim 1, wherein (i) comprises from 5 weight % to 50 weight % of the total weight of the reaction product; (ii) comprises 2 weight % to 15 weight % of the total weight of the reaction product; and (iii) comprises 35 weight % to 90 weight % of the total resin solids of the reaction product.

6. The polymer according to claim 1, wherein the reaction product has a molecular weight ranging from 500 to 2000.

7. A polymer consisting essentially of the reaction product of (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii); wherein the reaction product is not further reacted with any other monomer comprising an ethylenically unsaturated double bond; and wherein said reaction product comprises a reactive functional group.

8. A coating composition comprising:
(1) a polymer that comprises the reaction product of (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii); wherein the reaction product is not further reacted with any other monomer comprising an ethylenically unsaturated double bond; and wherein said reaction product comprises a functional group; and
(2) a crosslinking agent that is reactive with the functional group of the reaction product.

9. The coating composition according to claim 8, wherein said crosslinking agent comprises an isocyanate.

10. The coating composition according to claim 8, wherein the crosslinking agent comprises ≦40 weight % of the total resin solids of the coating composition.

11. The coating composition according to claim 10, wherein the crosslinking agent comprises 15 weight % to 30 weight % of the total resin solids of the coating composition.

12. The coating composition of claim 8, wherein said coating composition further comprises a polyester polyol.

13. The coating composition according to claim 12, wherein after application to a substrate and after curing, demonstrates a 20° gloss retention of at least 80% when subjected to SCRATCH TESTING METHOD 1.

14. The coating composition according to claim 12, wherein after application to a substrate and after curing, demonstrates a 20° gloss retention of at least 70% when subjected to SCRATCH TESTING METHOD 2.

15. The coating composition according to claim 12, wherein after application to a substrate and after curing, demonstrates a 20° gloss retention of at least 60% when subjected to SCRATCH TESTING METHOD 3.

16. The coating composition according to claim 12, wherein after application to a substrate and after curing, demonstrates a 20° gloss retention of at least 50% when subjected to SCRATCH TESTING METHOD 4.

17. The coating composition according to claim 12, wherein after application to a substrate and after curing, demonstrates a 20° gloss recovery of at least 5% when subjected to SCRATCH RECOVERY TESTING METHOD 1.

18. The coating composition according to claim 12, wherein after application to a substrate and after curing, demonstrates a 20° gloss recovery of at least 4% when subjected to SCRATCH RECOVERY TESTING METHOD 2.

19. The coating composition according to claim 12, wherein after application to a substrate and after curing, demonstrates a 20° gloss recovery of at least 3% when subjected to SCRATCH RECOVERY TESTING METHOD 3.

20. The coating composition according to claim 12, wherein after application to a substrate and after curing, demonstrates a 20° gloss recovery of at least 2% when subjected to SCRATCH RECOVERY TESTING METHOD 4.

21. A substrate coated with the coating composition of claim 8.

22. A method of forming a functional group containing polymer comprising:
(a) providing (i) a monomer comprising at least two ethylenically unsaturated double bonds; (ii) a monomer comprising a carbon atom that is connected to four moieties wherein one of said moieties comprises a hydrogen atom and the remainder of said moieties comprises an alkyl group, wherein one of the alkyl group containing moieties comprises an ethylenically unsaturated double bond, and wherein none of the alkyl group containing moieties form a cycloaliphatic ring; and (iii) at least one monomer that is reactive with (i) and/or (ii);
(b) providing a polymerization initiator;
(c) heating (a) and (b) thereby forming the polymer; and
wherein the polymer is not further reacted with any other monomer comprising an ethylenically unsaturated double bond.

23. The method according to claim 22, wherein (i) comprises a diacrylate.

24. The method according to claim 22, wherein (ii) comprises 2-ethyl hexyl(meth)acrylate, 2-butyl hexyl(meth)acrylate, 2-methyl hexyl(meth)acrylate, or combinations thereof.

25. The method according to claim 22, wherein (iii) comprises a hydroxy functional (meth)acryalte.
